(19) United States
(12) Patent Application Publication
(10) Pub. No.: US 2009/0102774 A1
(43) Pub. Date: Apr. 23, 2009

(54) ELECTRO-OPTICAL DEVICE

(75) Inventor: Yasunori HATTORI, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/190,336

(22) Filed: Aug. 12, 2008

(30) Foreign Application Priority Data
Oct. 22, 2007 (JP) 2007-273475

(51) Int. Cl. G09G 3/36

(52) U.S. Cl. 345/92

(57) ABSTRACT

Provided is an electro-optical device including a device substrate having a pixel region in which a plurality of pixels each including a pixel electrode and a pixel transistor are arranged, wherein, in the device substrate, a temperature detection resistance line extends along at least a half of the whole periphery of the pixel region on the periphery of the pixel region.

### BACKGROUND

1. Technical Field

The present invention relates to an electro-optical device such as a liquid crystal device or an organic electroluminescence (hereinafter, referred to as an organic EL).

2. Related Art

A representative example of an electro-optical device includes a liquid crystal device or an organic EL device. In a device substrate used in such an electro-optical device, a pixel region in which a plurality of pixels each including a pixel electrode and a pixel transistor are arranged is formed. In a liquid crystal device which is an electro-optical device, if a temperature is changed, a response speed or an optical characteristic of liquid crystal is changed. In an organic EL device, if a temperature is changed, the light emission characteristic of the organic EL device is changed and thus the quality of an image displayed by the electro-optical device deteriorates.

Accordingly, a technology of mounting a temperature sensor in an electro-optical device and adjusting a driving condition on the basis of the detected result of the temperature sensor is suggested (for example, see JP-A-8-29265, JP-A-2004-198503 and JP-A-2007-25685).

For example, in the configuration disclosed in JP-A-8-29265, a thin-film transistor is formed in a region sandwiched between a pixel region and a driving circuit and a resistance value of the thin-film transistor is changed by a temperature such that the temperature of the electro-optical device is monitored.

In the configuration disclosed in JP-A-2004-198503, a variation in resistance of a cathode ray which extends along one of a pixel region having a rectangular planar shape is detected such that the temperature of the electro-optical device is monitored.

In the configuration disclosed in JP-A-2007-25685, four resistance elements using metal lines are dotted with each other in opposing two sides of a pixel region having a rectangular planar shape such that the temperature of the electro-optical device is monitored.

However, since only the local temperature of the electro-optical device is monitored in JP-A-8-29265, JP-A-2004-198503 and JP-A-2007-25685, it is difficult to monitor the temperature of the whole pixel region. Accordingly, when a driving condition is changed on the basis of the detected result of the temperature sensor, an unnecessary variation or the adjustment of a reverse direction may occur.

In the configuration disclosed in JP-A-8-29265, it is difficult to realize enlargement since the thin-film transistor is used. In the configuration disclosed in JP-A-2004-198503, it is difficult to obtain temperature information from a wide region since the cathode ray is used. In addition, in the configuration disclosed in JP-A-2007-25685, when the resistance elements are increased, a wire which extends from the resistance element is increased and thus a wiring region cannot be ensured.

### SUMMARY

An advantage of some aspects of the invention is that it provides an electro-optical device, which is capable of monitoring the temperature of a whole pixel region with certainty even in the case where the area occupied by a temperature detection element or a temperature detection wire is small.

According to an aspect of the invention, there is provided an electro-optical device including a device substrate having a pixel region in which a plurality of pixels each including a pixel electrode and a pixel transistor are arranged, wherein, in the device substrate, a temperature detection resistance line extends along at least a half of the whole periphery of the pixel region on the periphery of the pixel region.

In the invention, since the resistance line is used as a temperature detection element for detecting the temperature of the pixel region, the area occupied by the temperature detection element may be small. Since the resistance line is used as the temperature detection element and the resistance line functions as a portion or the whole of a temperature detection wire, the area occupied by the temperature detection wire may not exist or may be narrow. Accordingly, although the resistance line extends along at least a half of the whole periphery of the pixel region, the other wires may be provided without any problem. Since the resistance line extends along at least a half of the whole periphery of the pixel region, it is possible to accurately detect the temperature of the pixel region and thus it is possible to properly adjust the driving condition in correspondence with the temperature of the pixel region.

In the invention, the resistance line may extend one end thereof and may be bent such that the other end thereof approaches one end thereof. A current value or a voltage value is detected from the both ends of the resistance line, but, if the both ends of the resistance line approach each other by bending the resistance line, the terminals for the resistance line can be provided in a narrow region even in the case where the resistance line extends in a wide region.

For example, the resistance line may have a planar shape in which one wire is folded midway on the periphery of the pixel region. By this configuration, since a state in which the pixel region is surrounded by the resistance line is avoided, it is possible to prevent an induced magnetic line from being intruded into the pixel region as noise even in the case where the induced magnetic line is generated from the resistance line, unlike the case where the resistance line is surrounded by the pixel region.

In the invention, the pixel region may have a rectangular planar shape, and the resistance line may extend along at least two adjacent sides of the pixel region. By this configuration, since the same monitoring result as the case where the temperature of the whole pixel region is monitored can be obtained, it is possible to properly adjust the driving condition in correspondence with the temperature of the pixel region.

In the invention, the resistance line may extend along at least three sides of the pixel region. By this configuration, since the same monitoring result as the case where the temperature of the whole pixel region is monitored can be obtained, it is possible to properly adjust the driving condition in correspondence with the temperature of the pixel region.

In the invention, the resistance line may be the same layer as any one of a plurality of conductive layers configuring the pixel transistor. By this configuration, it is possible to form the resistance line without adding a manufacturing process.

In the invention, the resistance line may be formed of a metal film. By this configuration, it is possible to accurately detect the temperature, compared with the case where the resistance line is formed of a semiconductor film. That is, while a resistance value may be changed by illumination intensity in the semiconductor film, the resistance value is hardly changed by the illumination intensity in the metal film. Accordingly, it is possible to accurately monitor the temperature of the pixel region regardless of the illumination intensity.

In the invention, a driving circuit may be formed on the outer side of the pixel region in the device substrate, and the resistance line may extend in a region sandwiched between the pixel region and the driving circuit. By this configuration, since the resistance line can extend in the vicinity of the pixel region, it is possible to accurately monitor the temperature of the pixel region, compared with the case where the resistance line extends on the outer side of the driving circuit.

In the invention, a signal line which extends from the pixel region to the driving circuit and the resistance line may be formed between different layers among a plurality of layers sandwiched by a plurality of insulating films. By this configuration, since the resistance line can extend in a direction crossing the signal which extends from the pixel region to the driving circuit, the resistance line can easily extend on the periphery of the pixel region.

In the invention, a signal line which extends from the pixel region to the driving circuit and the resistance line may be formed between the same layers among a plurality of layers sandwiched by a plurality of insulating films, and between the layers, the signal line may be disconnected in a portion in which the signal line and the resistance line cross each other and an interconnection bridge wire for electrically connecting the disconnected portions of the signal line may be formed between layers different from the layers. By this configuration, since the resistance line can extend in a direction crossing the signal which extends from the pixel region to the driving circuit, the resistance line can easily extend on the periphery of the pixel region.

In the case where the electro-optical device of the invention is a liquid crystal device, a liquid crystal layer may be held between the device substrate and a counter substrate which faces the device substrate.

In the case where the electro-optical device of the invention is an organic EL device, in the device substrate, a function layer for an organic electroluminescence element may be formed on the pixel electrode.

The electro-optical device of the invention is used as a direct-view monitor display unit in an electronic apparatus such as a mobile telephone or a mobile computer. The liquid crystal device (electro-optical device) of the invention may be used as a light valve of a projection display device.

### BRIEF DESCRIPTION OF THE DRAWINGS

The invention will be described with reference to the accompanying drawings, wherein like numbers reference like elements.

FIG. 1 is an equivalent circuit diagram showing the electrical configuration of a device substrate used in an electro-optical device (liquid crystal device) according to Embodiment 1 of the invention.

FIGS. 2A and 2B are a plan view of the electro-optical device according to Embodiment 1 of the invention when viewed from the side of a counter substrate together with components formed thereon and a cross-sectional view taken along line IIB-IIB thereof, respectively.

FIGS. 3A and 3B are a plan view of two adjacent pixels and a cross-sectional view of one pixel in the electro-optical device according to Embodiment 1 of the invention, respectively.

FIG. 4 is a block diagram showing the circuit configuration for correcting a driving condition on the basis of a temperature monitoring result in the electro-optical device according to the invention.

FIG. 5 is a graph showing a relationship between a temperature and resistance in the case where a metal film and a semiconductor film are used as a resistance line.

FIG. 6 is a cross-sectional view showing the configuration of the metal film used as the resistance line in the electro-optical device according to the invention.

FIG. 7 is an equivalent circuit diagram showing the electrical configuration of a device substrate used in an electro-optical device (liquid crystal device) according to Embodiment 2 of the invention.

FIG. 8 is a view illustrating noise generated due to the resistance line.

FIG. 9 is an equivalent circuit diagram showing the electrical configuration of a device substrate used in an electro-optical device (organic EL device) according to Embodiment 3 of the invention.

FIGS. 10A and 10B are a plan view of the electro-optical device according to Embodiment 3 of the invention when viewed from the side of a counter substrate together with components formed thereon and a cross-sectional view taken along line XB-XB thereof, respectively.

FIGS. 11A and 11B are a plan view of two adjacent pixels and a cross-sectional view of one pixel in the electro-optical device according to Embodiment 3 of the invention.

FIG. 12 is an equivalent circuit diagram showing the electrical configuration of a device substrate used in an electro-optical device (organic EL device) according to Embodiment 4 of the invention.

FIG. 13 is a view showing an electronic apparatus using the electro-optical device according to the invention.

### DESCRIPTION OF EXEMPLARY EMBODIMENTS

Hereinafter, embodiments of the invention will be described. In each view used for following description, the scale of each layer or each element is differentiated from each other in order that each layer or each element has a size capable of being identified in the view. In addition, although a source and a drain are exchanged by an applied voltage in a thin-film transistor, a side connected to a pixel electrode is the drain in the following description, for convenience of description.

### Embodiment 1

### Whole Configuration

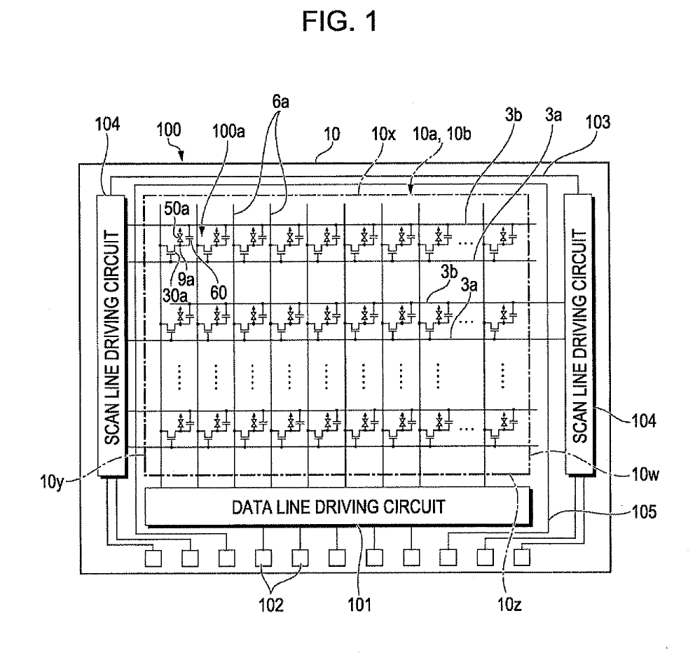

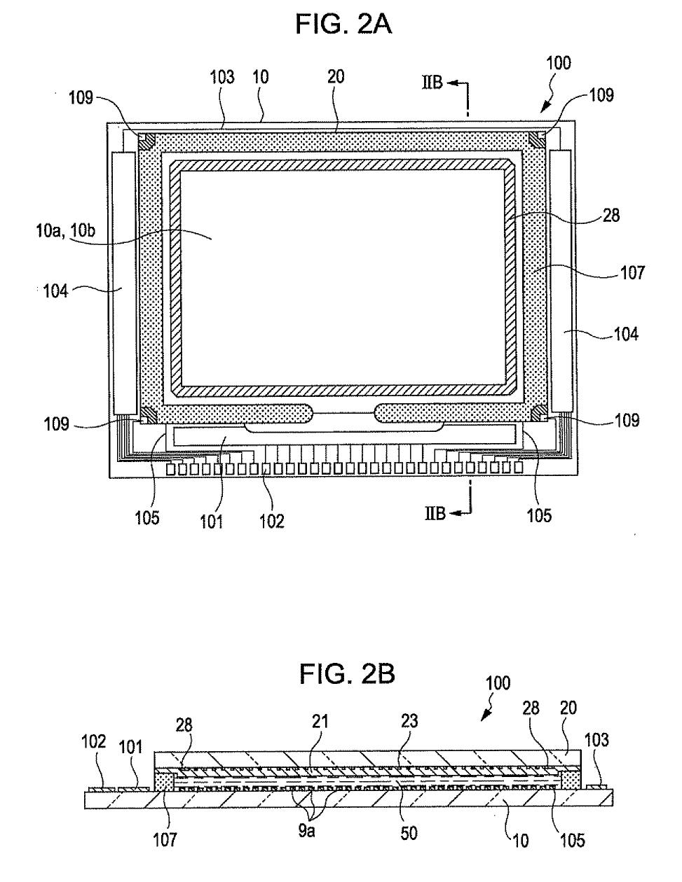

FIG. 1 is an equivalent circuit diagram showing the electrical configuration of a device substrate used in an electro-optical device (liquid crystal device) according to Embodiment 1 of the invention. FIGS. 2A and 2B are a plan view of the electro-optical device according to Embodiment 1 of the invention when viewed from the side of a counter substrate together with components formed thereon and a cross-sectional view taken along line IIB-IIB thereof, respectively.

As shown in FIG. 1, the electro-optical device 100 according to the present embodiment is a liquid crystal device and a plurality of pixels 100a are formed in a pixel region 10b having a rectangular planar shape in a matrix. In each of the plurality of pixels 100a, a pixel electrode 9a and a pixel switching thin-film transistor 30a (pixel transistor) for controlling the pixel electrode 9a are formed. Each of data lines 6a which extend from a data line driving circuit 101 are electrically connected to a source of the thin-film transistor 30a and the data line driving circuit 101 line-sequentially supplies image signals to the data lines 6a. Each of scan lines 3a which extend from a scan line driving circuit 104 is electrically connected to a gate of the thin-film transistor 30a and the scan line driving circuit 104 line-sequentially supplies scan signals to the scan lines 3a. The pixel electrode 9a is electrically connected to a drain of the thin-film transistor 30a. In the electro-optical device 100, the thin-film transistor 30a is turned on by a predetermined period such that the image signal supplied from each of the data lines 6a is written to liquid crystal capacitor 50a of each of the pixels 100a at a predetermined timing. The image signal having a predetermined level, which is written to the liquid crystal capacitor 50a, is held between the pixel electrode 9a formed on a device substrate 10 and a common electrode of a counter substrate for a predetermined period. A storage capacitor 60 is formed between the pixel electrode 9a and the common electrode and the voltage of the pixel electrode 9a is held in a time period three orders longer than a time period when the voltage of the source is applied. Accordingly, the charge holding characteristics are improved and the electro-optical device 100 with high contrast is realized. In the present embodiment, in the storage capacitor 60, a capacitive line 3b may be formed in parallel with each of the scan lines 3a or the storage capacitor 60 may be formed between a scan line 3a of a previous stage and a scan line of a current stage. In a fringe field switching (FFS) mode liquid crystal device, the common electrode is formed on the device substrate 10 together with the pixel electrode 9a.

In FIGS. 2A and 2B, the electro-optical device 100 according to the present embodiment is a transmissive active matrix type liquid crystal device. A seal material 107 is provided on the device substrate 10 in a rectangular frame shape and the counter substrate 20 and the device substrate 10 is bonded to each other by the seal material 107. The counter substrate 20 and the seal material 107 have the approximately same contour and liquid crystal 50 is held in a region surrounded by the seal material 107. The liquid crystal 50 is formed of, for example, one type or several types of nematic liquid crystal. In each portion of the seal material 107, a conductive material 109 for electrically connecting the device substrate 10 and the counter substrate 20 is provided.

In the device substrate 10, the data line driving circuit 101 and terminals 102 formed of indium tin oxide (ITO) are provided along one side of the device substrate 10 in an outer region of the seal material 107 (an outer region of the pixel region 10b). The terminals 102 are connected to a flexible circuit board (not shown) for electrical connection with an external circuit. In the device substrate 10, the scan line driving circuits 104 are formed along two sides adjacent to the side, along which the terminals 102 are arranged, in the outer region of the seal material 107 (the outer region of the pixel region 10b). A plurality of wires 103 for connecting the scan line driving circuits 104 located at the both sides of the image display region 10a are provided along the remaining side of the device substrate 10. In addition, a peripheral circuit such as a precharge circuit or a test circuit may be provided using the lower side of a frame 28 formed of a light-shielding film and formed on the counter substrate 20.

Although described in detail later, the pixel electrodes 9a are formed on the device substrate 10 in a matrix. In contrast, the frame 28 formed of the light-shielding film is formed on the counter substrate 20 in an inner region of the seal material 107 and the inside of the frame is the image display region 10a. In the counter substrate 20, a light-shielding film 23 called a black matrix or a black stripe is formed in regions opposite to vertical and horizontal boundary regions of the pixel electrodes 9a of the device substrate 10.

In the electro-optical device 100, the image display region 10a overlaps with the pixel region 10b described with reference to FIG. 1 and dummy pixels which do not directly contribute the display may be formed along the outer circumference of the pixel region 10b. In this case, the image display region 10a is constituted by a region excluding the dummy pixels in the pixel region 10b.

### Detailed Configuration of Pixel

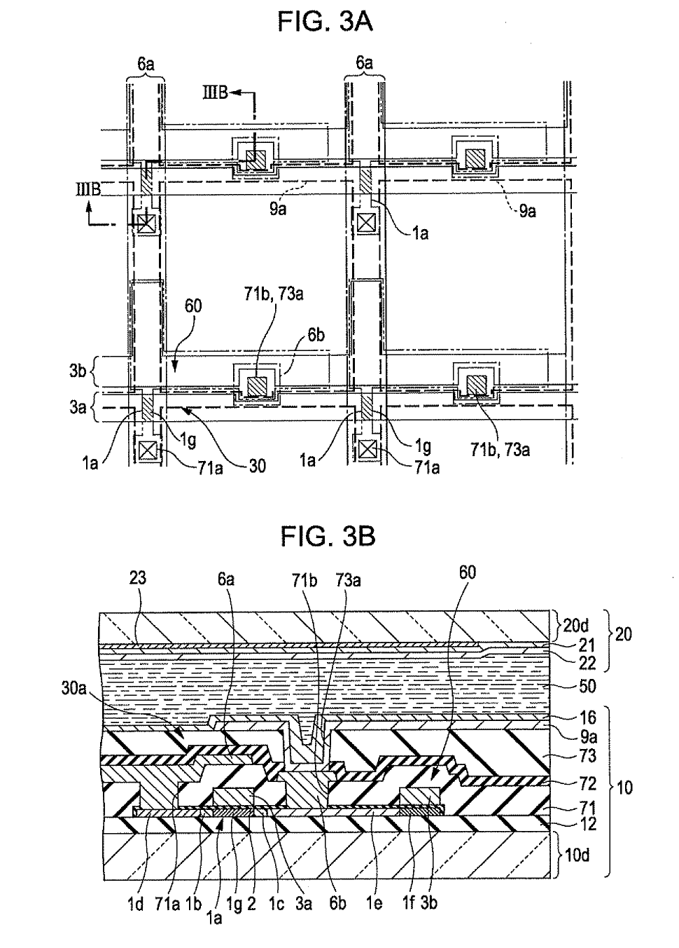

FIGS. 3A and 3B are a plan view of two adjacent pixels and a cross-sectional view of one pixel in the electro-optical device 100 according to Embodiment 1 of the invention, respectively. FIG. 3B is the cross-sectional view taken along line IIIB-IIIB of FIG. 3A. In FIG. 3A, the pixel electrodes 9a are denoted by long dotted lines, the data lines 6a and thin films which are simultaneously formed therewith are denoted by dashed dotted lines, the scan lines 3a are denoted by solid lines, and semiconductor layers are denoted by short dotted lines.

As shown in FIGS. 3A and 3B, on the device substrate 10, the plurality of transparent pixel electrodes 9a are formed in a matrix in correspondence with the pixels 100a in a matrix, and the data lines 6a and the scan lines 3a are formed along the vertical and horizontal boundary regions of the pixel electrodes 9a. In the device substrate 10, capacitive lines 3b are formed in parallel with the scan lines 3a.

The base of the device substrate 10 shown in FIG. 3B includes a support substrate 10d such as a quartz substrate or a heat-resistance glass substrate and the base of the counter substrate 20 includes a support substrate 20d such as a quartz substrate or a heat-resistance glass substrate. In the device substrate 10, a underlying insulating layer 12 formed of a silicon oxide film is formed on the surface of the support substrate 10d and the thin-film transistor 30a is formed on the surface thereof in a region corresponding to each of the pixel electrodes 9a. The thin-film transistor 30a has a lightly doped drain (LDD) structure in which a channel region 1g, a low-concentration source region 1b, a high-concentration source region 1d, a low-concentration drain region 1c, and a high-concentration drain region 1e are formed, with respect to an island semiconductor layer 1a. A gate insulating layer 2 formed of a silicon oxide film or a silicon nitride film is formed on the surface of the semiconductor layer 1a and a gate electrode (scan line 3a) is formed on the surface of the gate insulating layer 2. The semiconductor layer 1a is a single crystal silicon layer or a polysilicon film polycrystallized after forming an amorphous silicon film on the device substrate 10. Although the gate insulating film 2 is formed on the surface of the semiconductor layer 1a by thermal oxidation in FIG. 3B, the gate insulating layer 2 may be formed by a CVD method.

An interlayer insulating layer 71 formed of a silicon oxide film or a silicon nitride film, an interlayer insulating layer 72 formed of a silicon oxide film or a silicon nitride film and an interlayer insulating film 73 (planarization film) formed of photosensitive resin and having a thickness of 1.5 to 2.0 μm are formed on the thin-film transistor 30a. The data line 6a and a drain electrode 6b are formed on the surface of the interlayer insulating layer 71 (between the interlayer insulating films 71 and 72), and the data line 6a is electrically connected to the high-concentration source region 1d via a contact hole 71a formed in the interlayer insulating layer 71. The drain electrode 6b is electrically connected to the high-concentration drain region 1e via a contact hole 71b formed in the interlayer insulating layer 71.

The pixel electrode 9a formed of an ITO film is formed on the surface of the interlayer insulating layer 73. The pixel electrode 9a is electrically connected to the drain electrode 6b via a contact hole 73a formed in the interlayer insulating layers 72 and 73. An alignment film 16 formed of a polyimide film is formed on the surface of the pixel electrode 9a. The capacitive line 3b located at the same layer as the scan line 3a faces an extension if (lower electrode) from the high-concentration drain region 1e via an insulating layer (dielectric film) simultaneously formed with the gate insulating layer 2 as an upper electrode, thereby constituting the storage capacitor 60.

In the present embodiment, the scan line 3a and the capacitive line 3b are conductive films which are simultaneously formed and are formed of a single metal film, such as a molybdenum film, an aluminum film, a titanium film, a tungsten film, a tantalum film or a chrome film, or a lamination film thereof. The data line 6a and the drain electrode 6b are conductive films which are simultaneously formed and are formed of a single metal film, such as a molybdenum film, an aluminum film, a titanium film, a tungsten film, a tantalum film or a chrome film, or a lamination film thereof. The terminals 102 shown in FIGS. 1, 2A and 2B are formed of the ITO film electrically connected to the wires, which are simultaneously formed with the scan line 3a and the data line 6a, via the contact hole formed in the interlayer insulating films 71, 72 and 73 and the contact hole formed in the interlayer insulating films 72 and 73.

In the counter substrate 20, the common electrode 21 formed of the ITO film is formed on the light-shielding film 23 and an alignment film 22 is formed on the surface thereof. In the case where the electro-optical device 100 is for a color display, color filters (not shown) are formed on the counter substrate 20 in correspondence with the plurality of pixels 100a.

The device substrate 10 and the counter substrate 20 are disposed such that the pixel electrode 9a and the common electrode 21 face each other. The liquid crystal 50 is filled in a space surrounded by the seal material 107 (see FIGS. 2A and 2B) between the both substrates as the electro-optical material. The liquid crystal 50 is in a predetermined alignment state by the alignment films 16 and 22 in a state in which an electric field from the pixel electrodes 9a is not applied.

### Configuration for Temperature Compensation

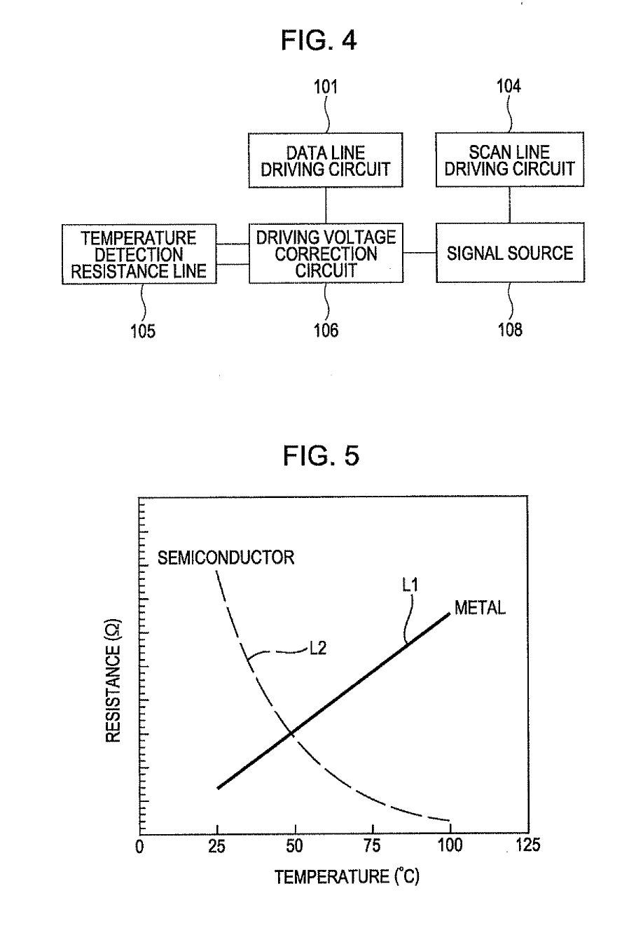

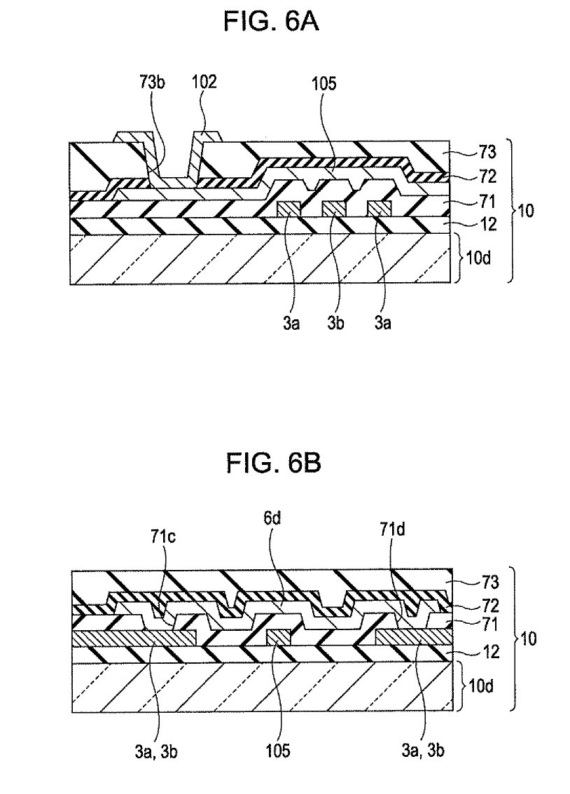

FIG. 4 is a block diagram showing the circuit configuration for correcting a driving condition on the basis of a temperature monitoring result in the electro-optical device according to the invention. FIG. 5 is a graph showing a relationship between a temperature and resistance in the case where a metal film and a semiconductor film are used as a resistance line. FIG. 6 is a cross-sectional view showing the configuration of the metal film used as the resistance line in the electro-optical device according to the invention.

Referring to FIG. 1 again, in the device substrate 10, the resistance line 105 is formed on the periphery of the pixel region 10b as a temperature detection element for detecting the temperature of the pixel region 10b. In the present embodiment, the resistance line 105 extends along at least a half of the whole periphery of the pixel region 10b on the periphery of the pixel region. In more detail, the resistance line 105 extends along three adjacent sides 10w, 10x and 10y among four sides 10w, 10x, 10y and 10z of the pixel region 10b having a rectangular planar shape, and the both ends thereof pass through the both sides of the data line driving circuit 101 and are connected to two terminals 102 of the plurality of terminals 102 arranged in parallel with the side 10z of the pixel region 10b with the data line driving circuit 101 interposed therebetween. Accordingly, the resistance line 105 extend from one end thereof along the sides 10w, 10x and 10y of the pixel region 10b while being bent and is bent such that the other end thereof approaches one end thereof in plan view.

In the present embodiment, in the device substrate 10, the data line driving circuit 101 and the scan line driving circuits 104 are formed on the outer circumference side of the pixel region 10b and a portion of the resistance line 105 which extends along the sides 10w and 10y of the pixel region 10b extends in the regions sandwiched between the pixel region 10b and the scan line driving circuits 104. In the regions sandwiched between the pixel region 10b and the scan line driving circuits 104, as shown in FIG. 2A, the resistance line 105 may extend in a region overlapping with a region sandwiched between the frame 28 and the seal material 107, a region overlapping with the seal material 107, or an outer region of the seal material 107, in addition to a region overlapping the frame 28. Although the scan line driving circuits 104 are formed in regions overlapping with the seal material 107, the resistance line 105 extend in the regions sandwiched between the pixel region 10b and the scan line driving circuits 104.

Since the resistance value of the resistance line 105 is changed according to a temperature change as described below, a constant voltage is applied via the terminal 102 connected to the resistance line 105 such that a current value is measured and the change in the resistance value of the resistance line 105 is detected on the basis of the measured result such that the temperature of the pixel region 10b is monitored. Alternatively, constant current is applied to the resistance line 105 via the terminal 102 such that the voltage value therebetween is measured and the change in resistance value of the resistance line 105 is detected on the basis of the measured result such that the temperature of the pixel region 10b is monitored. The temperature monitoring result of the pixel region 10b is used for correcting the driving condition by the circuit shown in FIG. 4 so as to compensate for the temperature.

In the circuit shown in FIG. 4, a signal source 108 outputs a data signal and a clock signal for enabling the data line driving circuit 101 and the scan line driving circuits 104 to output the image signals and the scan signals. The data signal is output from the signal source 108 and is input to the data line driving circuit 101 via a driving voltage correction circuit 106. The driving voltage correction circuit 106 is electrically connected to the temperature detection resistance line 105 (temperature detection element) and the driving voltage correction circuit 106 adjusts the amplification level of the data line on the basis of the resistance change of the resistance line 105. That is, since the slope of an applied voltage-transmissivity curve of the liquid crystal 50 is low in the case where the temperature is low and is rapid in the case where the temperature is high, the data signal is corrected according to the temperature of the pixel region 10b and a proper gradation display is performed. For example, the voltage applied to the liquid crystal 50 is increased if the temperature is low and the voltage applied to the liquid crystal 50 is decreased if the temperature is high.

The resistance line 105 is formed by linearly patterning the metal film and the semiconductor film. If the resistance line 105 is formed of the metal film, as denoted by a solid line L1 of FIG. 5, the resistance is increased as the temperature is increased. In contrast, if the resistance line 105 is formed of the semiconductor film, as denoted by a dotted line L2 of FIG. 5, the resistance is decreased as the temperature is increased. The resistance line 105 can be simultaneously formed with the conductive film (the metal film and the semiconductor film) configuring the thin-film transistor 30a and thus, in the present embodiment, the metal film and the resistance line 105 configuring the thin-film transistor 30a are simultaneously formed.

That is, in the present embodiment, as shown in FIG. 6A, the resistance line 105 is formed by the metal film which is simultaneously formed with the data line 6a and the resistance line 105 is formed of a single metal film, such as a molybdenum film, an aluminum film, a titanium film, a tungsten film, a tantalum film or a chrome film, or a lamination film thereof. Accordingly, the resistance line 105 is formed between the interlayer insulating films 71 and 72. Since the resistance line 105 is formed in the regions sandwiched between the pixel region 10b and the scan line driving circuits 104, the resistance line 105, and the scan lines 3a and the capacitive lines 3b cross each other. However, the scan lines 3a and the capacitive lines 3b are formed between the underlying insulating layer 12 and the interlayer insulating film 71, the resistance line 105, and the scan lines 3a and the capacitive lines 3b are formed between different layers. Accordingly, the resistance lines 105, and the scan lines 3a and the capacitive lines 3b are not short-circuited. The terminal 102 connected to the resistance line 105 is formed of the ITO film formed on the surface of the interlayer insulating film 73 and thus is electrically connected to the resistance line 105 via a contact hole 73b formed in the interlayer insulating films 72 and 73.

The resistance line 105 may be formed of the metal film which is simultaneously formed with the scan lines 3Sa and, even in this case, is formed of a single metal film, such as a molybdenum film, an aluminum film, a titanium film, a tungsten film, a tantalum film or a chrome film, or a lamination film thereof. In this case, all the resistance line 105, the scan lines 3a and the capacitive lines 3b are formed between the underlying insulating layer 12 and the interlayer insulating film 71. In this case, as shown in FIG. 6B, a portion in which the scan lines 3a and the capacitive lines 3b are disconnected is formed in the cross portion between the resistance line 105, and the scan lines 3a and the capacitive lines 3b, and an interconnection bridge wire 6d is simultaneously formed between the interlayer insulating films 71 and 72 with the data lines 6a. Since the interconnection bridge wire 6d is electrically connected to the scan lines 3a and the capacitive lines 3b via contact holes 71c and 71d, the portion in which the scan lines 3a and the capacitive lines 3b are disconnected may be formed.

The configuration using the interconnection bridge wire may be applied to the case where the data lines 6a and the resistance line 105 cross each other in the case where the resistance line 105 is formed by the metal film which is simultaneously formed with the data lines 6a.

### Main Effect of Present Embodiment

As described above, in the electro-optical device 100 according to the present embodiment, since the resistance line 105 is used as the temperature detection element for detecting the temperature of the pixel region 10b, the area occupied by the temperature detection element may be small. Since the resistance line 105 is used as the temperature detection element and the resistance line 105 functions as the temperature detection wire, the area occupied by the temperature detection wire does not exist. Accordingly, although the resistance line 105 extends over at least a half of the whole periphery of the pixel region 10b, the other wires can be formed without any problem. In addition, since the resistance element 105 extends over at least a half of the whole periphery of the pixel region 10b, the temperature of the pixel region 10b can be accurately detected. Therefore, the driving condition of the pixels 100a can be properly adjusted according to the temperature of the pixel region 10b.

In addition, since the resistance line 105 extends in the regions sandwiched between the pixel region 10b and the driving line driving circuits 104, the resistance line 105 is located in the vicinity of the pixel region 10b. Accordingly, the temperature of the pixel region 10b can be accurately monitored.

Since the resistance 105 extends from one end and is bent such that the other end approaches one end, the resistance line 105 can be electrically connected to the terminals 102 arranged along the sides of the device substrate 10. Therefore, even in the case where the resistance line 105 extends over a wide region, the terminals 102 can be disposed in a narrow region.

Since the resistance line 105 can be formed on the same layer as any one of the plurality of conductive layers configuring the thin-film transistor 30a, a manufacturing process does not need to be added.

The resistance line 105 may be formed of the metal film and the semiconductor film. However, in the present embodiment, since the resistance line is formed of the metal film, the temperature can be accurately detected. That is, if the semiconductor film is used, the resistance value may be changed according to illumination intensity. In contrast, if the metal film is used, the resistance value is hardly changed. Accordingly, the temperature of the pixel region 10b can be accurately monitored regardless of the illumination intensity.

### Embodiment 2

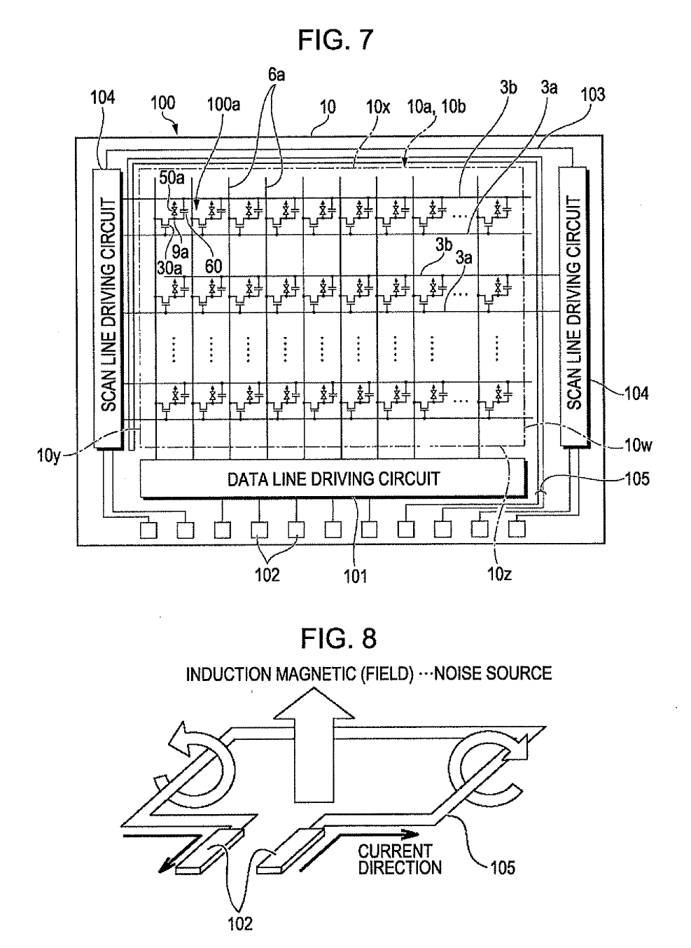

FIG. 7 is an equivalent circuit diagram showing the electrical configuration of a device substrate used in an electro-optical device (liquid crystal device) according to Embodiment 2 of the invention. FIG. 8 is a view illustrating noise generated due to the resistance line. Since the basic configuration of the present embodiment is equal to that of Embodiment 1, the common portions are denoted by the same reference numerals and the description thereof will be omitted.

An electro-optical device 100 shown in FIG. 7 is a liquid crystal device, similar to Embodiment 1. A plurality of pixels 100a are formed in a pixel region 10b having a rectangular planar shape in a matrix.

In the present embodiment, in the device substrate 10, a resistance line 105 is formed on the periphery of the pixel region 10b as a temperature detection element for detecting the temperature of the pixel region 10b. In the present embodiment, the resistance line 105 extends along at least a half of the whole periphery of the pixel region 10b on the periphery of the pixel region. In more detail, the resistance line 105 extends along three adjacent sides 10w. 10x and 10y among four sides 10w, 10x, 10y and 10z of the pixel region 10b having a rectangular planar shape, and the both ends thereof are connected two adjacent terminals 102 among the plurality of terminals 102 in parallel with the side 10z of the pixel region 10b with the data line driving circuit 101 interposed therebetween. That is, the resistance line 105 extends from one end thereof along the sides 10w, 10x and 10y of the pixel region 10b while being bent, folds at a portion formed by the sides 10y and 10z of the pixel region 10b, and extends along the sides 10y, 10x and 10w of the pixel region 10b while being bent such that the other end thereof approaches one end thereof.

In the device substrate 10, a data line driving circuit 101 and scan line driving circuits 104 are formed on the outer side of the pixel region 10b and the portion of the resistance line 105 which extends along the sides 10w and 10y of the pixel region 10b extends in regions sandwiched between the pixel region 10b and the scan line driving circuits 104.

The other configuration of the resistance line 105 is equal to that of Embodiment 1 and the description thereof will be omitted. However, since the resistance line 105 extends over at least a half of the whole periphery of the pixel region 10b, the same effect as Embodiment 1 can be obtained, that is, the temperature of the pixel region 10b can be accurately detected.

In the present embodiment, since the resistance line 105 does not surround the pixel region 10b, as shown in FIG. 8, even in the case where an induced magnetic line is generated from the resistance line 105 when current flows in the resistance line 105, the induced magnetic line is not intruded into the pixel region 10b as noise.

### Embodiment 3

Hereinafter, an example of applying the invention to an organic EL device will be described. In the following description, corresponding portions are denoted by the same reference numerals in order to easily understand the correspondence with Embodiments 1 and 2.

### Whole Configuration

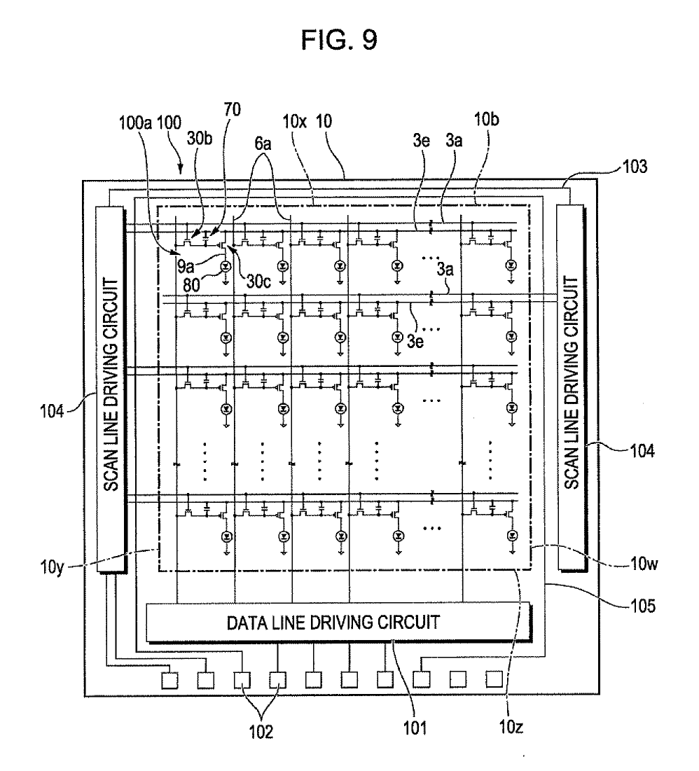

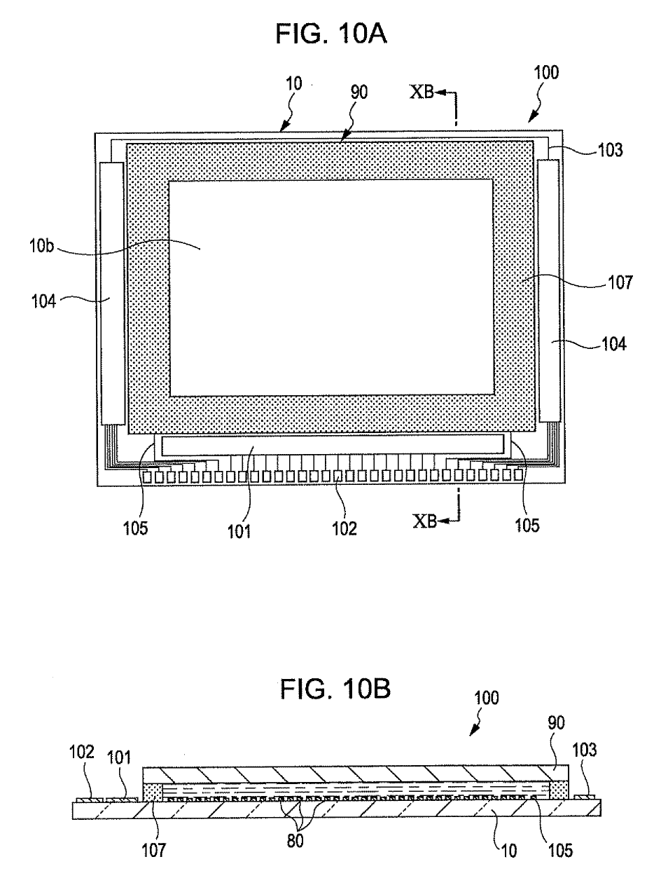

FIG. 9 is an equivalent circuit diagram showing the electrical configuration of a device substrate used in an electro-optical device (organic EL device) according to Embodiment 3 of the invention. FIGS. 10A and 10B are a plan view of the electro-optical device according to Embodiment 3 of the invention when viewed from the side of a counter substrate together with components formed thereon and a cross-sectional view taken along line XB-XB thereof, respectively.

The electro-optical device 100 shown in FIG. 9 is an organic EL device. On a device substrate 10, a plurality of scan lines 3a, a plurality of data lines 6a which extend in a direction crossing the scan lines 3a, and a plurality of power source lines 3e which extend in parallel with the scan lines 3a are formed. In the device substrate 10, a plurality of pixels 100a are arranged in a rectangular pixel region 10b in a matrix. The data lines 6a are connected to a data line driving circuit 101 and the scan lines 3a are connected to scan line driving circuits 104. In the pixel region 10b, switching thin-film transistors 30b in which scan signals are supplied to the gate electrodes thereof via the scan lines 3a, storage capacitors 70 for holding pixel signals supplied from the data lines 6a via the switching thin-film transistors 30b, driving thin-film transistors 30c in which the pixel signals held by the storage capacitors 70 are supplied to the gate electrodes thereof, pixel electrodes 9a (anode layers) into which driving current flows from the power source lines 3e when being electrically connected to the power source lines 3e via the thin-film transistors 30c, and organic EL elements 80 of which organic function layers are sandwiched between the pixel electrodes 9a and the anode layers are formed.

According to the above-described configuration, when the scan lines 3a are driven such that the switching thin-film transistors 30b are turned on, the potentials of the data lines 6a are held by the storage capacitors 70 and the ON/OFF state of the driving thin-film transistors 30c are decided according to the charges held by the storage capacitors 70. Current flows from the power source lines 3e to the pixel electrodes 9a via the channels of the driving thin-film transistors 30c and flows into the opposite-polarity layers via the organic function layers. As a result, the organic EL elements 80 emit light according to the amount of current flowing therein.

Although the power source lines 3e are provided in the parallel with the scan lines 3a in the configuration shown in FIG. 9, the configuration in which the power source lines 3e are provided in parallel with the data lines 6a may be employed. Although the storage capacitors 70 are configured by the power source lines 3e in the configuration shown in FIG. 9, capacitive lines may be formed independent of the power source lines 3e and the storage capacitors 70 may be configured by these capacitive lines.

In FIGS. 10A and 10b, in the electro-optical device 100 of the present embodiment, the device substrate 10 and a sealing substrate 90 are bonded by a seal material 107 and a drying agent (not shown) is received between the device substrate 10 and the sealing substrate 90. In the device substrate 10, in the outer region of the seal material 107, the data line driving circuit 101 and terminals 102 formed of an ITO film are provided along one side of the device substrate 10 and the scan line driving circuits 104 are formed along two sides adjacent to the side along which the terminals 102 are arranged. A plurality of wires 103 for connecting the scan line driving circuits 104 provided on the both sides of an image display region 10a are provided along the remaining side of the device substrate 10. Although described in detail later, in the device substrate 10, the organic EL elements 80 in which the pixel electrodes (anodes), organic function layers and cathodes are laminated in this order are formed in a matrix. A structure in which the device substrate 10 is covered by sealing resin may be employed, instead of the sealing substrate 90.

### Detailed Configuration of Pixel

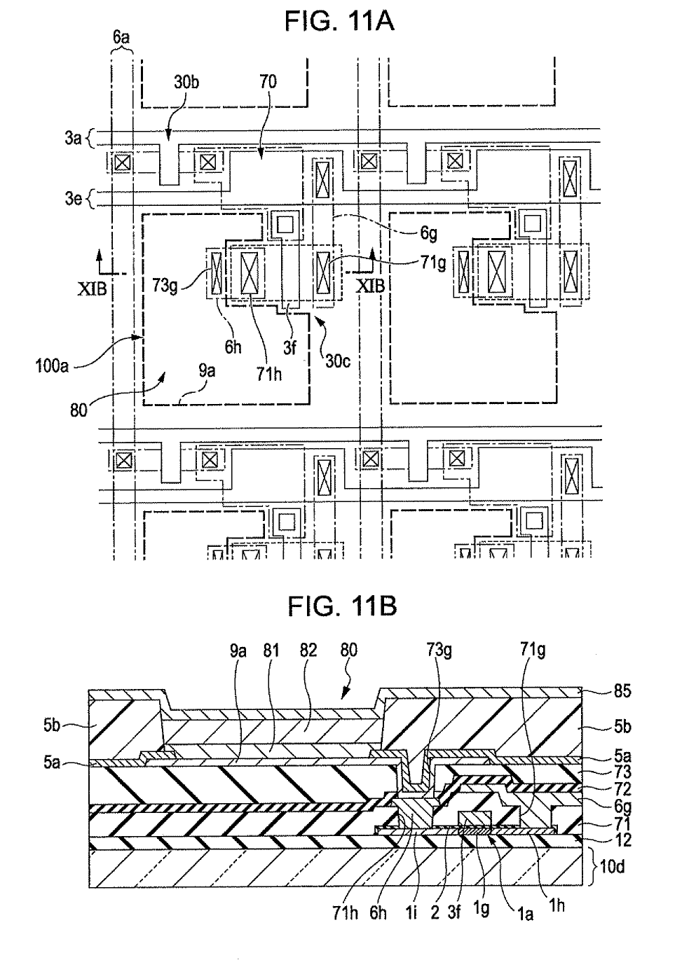

FIGS. 11A and 11B are a plan view of two adjacent pixels and a cross-sectional view of one pixel in the electro-optical device 100 according to Embodiment 3 of the invention. FIG. 11B is the cross-sectional view taken along line XIB-XIB of FIG. 11A. In FIG. 11A, the pixel electrodes 9a are denoted by long dotted lines, the data lines 6a and thin films which are simultaneously formed therewith are denoted by dashed dotted lines, the scan lines 3a are denoted by solid lines, and semiconductor layers are denoted by short dotted lines.

As shown in FIGS. 11A and 11B, on the device substrate 10, the plurality of transparent pixel electrodes 9a are formed in a matrix in correspondence with the pixels 100a in a matrix, and the data lines 6a (regions denoted by a dashed dotted line) and the scan lines 3a (regions denoted by a solid line) are formed along the vertical and horizontal boundary regions of the pixel electrodes 9a. in the device substrate 10, the capacitive lines 3e are formed in parallel with the scan lines 3a.

The base of the device substrate 10 shown in FIG. 11B includes a support substrate 10d such as a quartz substrate or a heat-resistance glass substrate. In the device substrate 10, a underlying insulating layer 12 formed of a silicon oxide film is formed on the surface of the support substrate 10d and the thin-film transistors 30c are formed on the surface thereof in a region corresponding to the pixel electrodes 9a. In each of the thin-film transistors 30c, a channel region 1g, a source region 1h and a drain region 1i are formed with respect to an island semiconductor layer 1a. A gate insulating layer 2 is formed on the surface of the semiconductor layer 1a and a gate electrode 3f is formed on the surface of the gate insulating layer 2. The gate electrode 3f is electrically connected to the drain of each of the thin-film transistors 30b. The basic configuration of the thin-film transistors 30b is equal to that of the thin-film transistors 30c and the description thereof will be omitted.

An interlayer insulating layer 71 formed of a silicon oxide film or a silicon nitride film, an interlayer insulating layer 72 formed of a silicon oxide film or a silicon nitride film and an interlayer insulating film 73 (planarization film) formed of photosensitive resin and having a thickness of 1.5 to 2.0 μm are formed on the thin-film transistors 30c. A source electrode 6g and a drain electrode 6h are formed on the surface of the interlayer insulating layer 71 (between the interlayer insulating films 71 and 72), and the data electrode 6g is electrically connected to the source region 1h via a contact hole 71g formed in the interlayer insulating layer 71. The drain electrode 6h is electrically connected to the drain region 1i via a contact hole 71h formed in the interlayer insulating layer 71.

The pixel electrode 9a formed of an ITO film is formed on the surface of the interlayer insulating layer 73. The pixel electrode 9a is electrically connected to the drain electrode 6h via a contact hole 73a formed in the interlayer insulating layers 72 and 73.

A barrier layer 5a formed of a silicon oxide film having an opening for defining a light emission region and a thick barrier layer 5b formed of photosensitive resin are formed on the pixel electrode 9a. In a region surrounded by the barrier layer 5a and the barrier layer 5b, an organic function layer including a hole injection layer 81 formed of 3,4-polyethylenedioxythiophene/polystyrene sulfonate (PEDOT/PSS) and a light emission layer 82 is formed on the pixel electrode 9a and a cathode layer 85 is formed on the light emission layer 82. The pixel electrode 9a, the hole injection layer 81, the light emission layer 82 and the cathode layer 85 configure the organic EL element 80. The light emission layer 82 is formed of, for example, a polyfluorene derivative, a polyphenylene derivative, polyvinyl carbazole, a polythiophene derivative, or a material obtained by doping perylene-based pigment, coumalin-based pigment or rhodamine-based pigment, for example, rubrene, perylene, 9,10-diphenylanthracene, tetraphenylbutadiene, Nile Red, coumaline 6 or quinacridone to these polymer materials. As the light emission layer 82, a π-conjugated macromolecular substance in which double-bonded π electrons are not localized on a polymer chain is a conductive polymer is suitably used due to excellent light emission performance. In particular, a compound having fluorene skeleton in molecules, that is, a polyfluorene-based compound, is more suitably used. In addition to these materials, a precursor of a conjugated macromolecular organic compound or a composition including at least one fluorescent pigment for changing the light emission characteristic may be used. In the present embodiment, the organic function layer is formed by a coating method such as an ink jet method. As the coating method, a flexographic printing method, a spin coating method, a slit coating method or a die coating method may be employed. The organic function layer may be formed by a deposition method. An electron injection layer formed of LiF may be formed between the light emission layer 82 and the cathode layer 85.

In a top emission organic EL device, since light is received from the side, in which the organic EL element 80 is formed, when viewed from the support substrate 10d, the cathode layer 85 is formed of a light transmission electrode such as an ITO film obtained by bonding a thin film such as a thin aluminum film or a magnesium or lithium film and adjusting a work function, and a transparent substrate such as glass or an opaque substrate may be used as the support substrate 10d. As the opaque substrate, for example, a substrate obtained by performing an insulating process such as surface oxidation with respect to a metal plate such as ceramics such as alumina or stainless steel or a resin substrate may be used. In contrast, in a bottom emission organic EL device, since the light is received from the side of the support substrate 10d, a transparent substrate such as glass is used as the support substrate 10d.

### Configuration for Temperature Compensation

Referring to FIG. 9 again, in the present embodiment, in the device substrate 10, the resistance line 105 is formed on the periphery of the pixel region 10b as a temperature detection element for detecting the temperature of the pixel region 10b. In the present embodiment, the resistance line 105 extends along at least a half of the whole periphery of the pixel region 10b on the periphery of the pixel region. In more detail, the resistance line 105 extends along three adjacent sides 10w, 10x and 10y among four sides 10w, 10x, 10y and 10z of the pixel region 10b having a rectangular planar shape, and the both ends thereof pass through the both sides of the data line driving circuit 101 and are connected to two terminals 102. Accordingly, the resistance line 105 extend from one end thereof along the sides 10w, 10x and 10y of the pixel region 10b while being bent and is bent such that the other end thereof approaches one end thereof in plan view. In addition, in the device substrate 10, the data line driving circuit 101 and the scan line driving circuits 104 are formed on the outer circumference side of the pixel region 10b and a portion of the resistance line 105 which extends along the sides 10w and 10y of the pixel region 10b extends in the regions sandwiched between the pixel region 10b and the scan line driving circuits 104.

Since the resistance value of the resistance line 105 is changed according to a temperature change, similar to Embodiment 1, the temperature of the pixel region 10b is monitored by the resistance line 105 and the temperature monitoring result is used for correcting the driving condition of the pixels 100a by the circuit described with reference to FIG. 4. That is, since the slope of an applied current-brightness curve of the organic EL element 80 is changed by the temperature, the data signals are corrected according to the temperature of the pixel region 10b and a proper gradation display is performed.

Even in the present embodiment, similar to Embodiment 1, since the resistance line 105 can be formed by linearly patterning a metal film and a semiconductor film, the resistance line 105 is formed by the metal film which is simultaneously formed with the data lines 6a or the source electrode 6g and the metal film which is simultaneously formed with the scan lines 3a Accordingly, the resistance film 105 is formed of formed of a single metal film, such as a molybdenum film, an aluminum film, a titanium film, a tungsten film, a tantalum film or a chrome film, or a lamination film thereof.

Even in this configuration, since the resistance line 105 extends over at least a half of the whole periphery of the pixel region 10b, the same effect as Embodiment 1 can be obtained, that is, the temperature of the pixel region 10b can be accurately detected.

### Embodiment 4

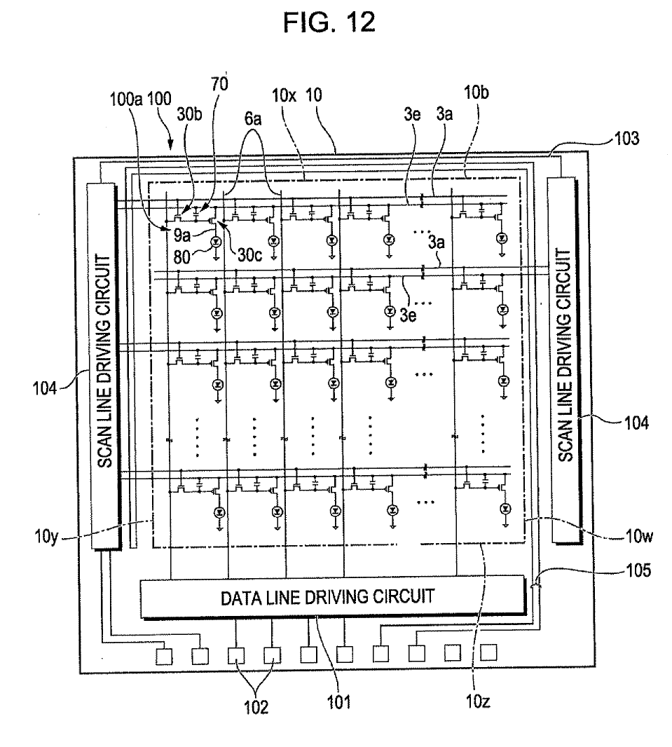

FIG. 12 is an equivalent circuit diagram showing the electrical configuration of a device substrate used in an electro-optical device (organic EL device) according to Embodiment 4 of the invention. Since the basic configuration of the present embodiment is equal to that of Embodiment 3, the common portions are denoted by the same reference numerals and the description thereof will be omitted.

The electro-optical device 100 shown in FIG. 12 is an organic EL device, similar to Embodiment 3. A plurality of pixels 100a are formed in a pixel region 10b having a rectangular planar shape in a matrix.

In the present embodiment, in the device substrate 10, a resistance line 105 is formed on the periphery of the pixel region 10b as a temperature detection element for detecting the temperature of the pixel region 10b. In the present embodiment, the resistance line 105 extends along at least a half of the whole periphery of the pixel region 10b on the periphery of the pixel region. In more detail, the resistance line 105 extends along three adjacent sides 10w. 10x and 10y among four sides 10w, 10x, 10y and 10z of the pixel region 10b having a rectangular planar shape, and the both ends thereof are connected two adjacent terminals 102 among the plurality of terminals 102 in parallel with the side 10z of the pixel region 10b with the data line driving circuit 101 interposed therebetween. That is, the resistance line 105 extends from one end thereof along the sides 10w, 10x and 10y of the pixel region 10b while being bent, folds at a portion formed by the sides 10y and 10z of the pixel region 10b, and extends along the sides 10y, 10x and 10w of the pixel region 10b while being bent such that the other end thereof approaches one end thereof.

In the device substrate 10, a data line driving circuit 101 and scan line driving circuits 104 are formed on the outer side of the pixel region 10b and the portion of the resistance line 105 which extends along the sides 10w and 10y of the pixel region 10b extends in regions sandwiched between the pixel region 10b and the scan line driving circuits 104.

The other configuration of the resistance line 105 is equal to that of Embodiment 3 and the description thereof will be omitted. However, since the resistance line 105 extends over at least a half of the whole periphery of the pixel region 10b, the same effect as Embodiment 3 can be obtained, that is, the temperature of the pixel region 10b can be accurately detected.

In the present embodiment, since the resistance line 105 does not surround the pixel region 10b, as described with reference to FIG. 8, even in the case where an induced magnetic line is generated from the resistance line 105 when current flows in the resistance line 105, the induced magnetic line is not intruded into the pixel region 10b as noise.

### Other Embodiments

Although the resistance line 105 is formed by the metal film in the above-described embodiments, the resistance line 105 may be formed by making the semiconductor film, which is simultaneously formed with the semiconductor layer configuring an active layer of the thin-film transistor, conductive. In the case where the data lines or the scan lines are formed of a conductive polysilicon layer, the resistance line 105 and the conductive polysilicon layer may be simultaneously formed.

Although the terminals 102 and the data line driving circuit 101 are formed along the same side of the device substrate 10 in the above-described embodiments, the invention may be applied to the case where the terminals 102 and the data line driving circuit 101 are configured such that they are formed along opposing two sides in the device substrate 10. Although the resistance line 105 and the terminals 102 are electrically connected and the driving condition of the external circuit is corrected in the above-described embodiments, the resistance line 105 may be routed toward the inside of the data line driving circuit 101 according to a circuit method.

Although the data line driving circuit 101 and the scan line driving circuits 104 are formed on the device substrate 10 in the above-described embodiments, the invention may be applied to an electro-optical device in which the driving circuit is not formed on the device substrate 10.

### Mount Example of Electronic Apparatus

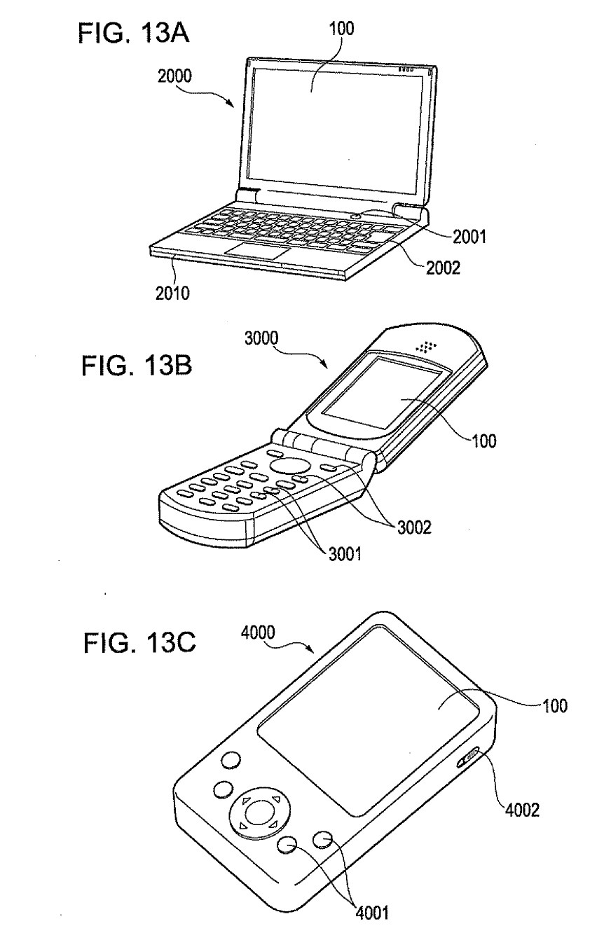

Next, an electronic apparatus using the electro-optical device 100 according to the above-described embodiments will be described. FIG. 13A shows the configuration of a mobile personal computer including the electro-optical device 100. The personal computer 2000 includes the electro-optical device 100 as a display unit and a main body 2010. The main body 2010 includes a power source switch 2001 and a keyboard 2002. FIG. 13B shows the configuration of a mobile telephone including the electro-optical device 100. The mobile telephone 3000 includes a plurality of operation buttons 3001, a scroll button 3002 and the electro-optical device 100 as a display unit. By operating the scroll button 3002, a screen of the electro-optical device 100 is scrolled. FIG. 13C shows the configuration of a personal digital assistants (PDA) including the electro-optical device 100. The PDA 4000 includes a plurality of operation buttons 4001, a power source switch 4002 and the electro-optical device 100 as a display unit. When the power source switch 4002 is operated, a variety of information such as an address book or a schedule book is displayed on the electro-optical device 100.

As the electronic apparatus including the electro-optical device 100, in addition to the electronic apparatus described in FIG. 13, there are a cellular phone, a liquid crystal television set, a viewfinder-type or direct-view monitor type video tape recorder, a car navigation system, a pager, an electronic organizer, an electronic calculator, a word processor, a workstation, a videophone, a POS terminal, and a touch-panel-equipped device. The above-described electro-optical device 100 is applicable as a display unit of such exemplary electronic apparatuses.

What is claimed is:

1. An electro-optical device including a device substrate having a pixel region in which a plurality of pixels each including a pixel electrode and a pixel transistor are arranged, wherein, in the device substrate, a temperature detection resistance line extends along at least a half of the whole periphery of the pixel region on the periphery of the pixel region.

2. The electro-optical device according to claim 1, wherein the resistance line extends one end thereof and is bent such that the other end thereof approaches one end thereof.

3. The electro-optical device according to claim 2, wherein the resistance line has a planar shape in which one wire is folded midway.

4. The electro-optical device according to claim 1, wherein:
the pixel region has a rectangular planar shape, and
the resistance line extends along at least two adjacent sides of the pixel region.

5. The electro-optical device according to claim 4, wherein the resistance line extends along at least three sides of the pixel region.

6. The electro-optical device according to claim 1, wherein the resistance line is the same layer as any one of a plurality of conductive layers configuring the pixel transistor.

7. The electro-optical device according to claim 1, wherein the resistance line is formed of a metal film.

8. The electro-optical device according to claim 1, wherein:
a driving circuit is formed on the outer side of the pixel region in the device substrate, and
the resistance line extends in a region sandwiched between the pixel region and the driving circuit.

9. The electro-optical device according to claim 8, wherein a signal line which extends from the pixel region to the driving circuit and the resistance line are formed between different layers among a plurality of layers sandwiched by a plurality of insulating films.

10. The electro-optical device according to claim 8, wherein a signal line which extends from the pixel region to the driving circuit and the resistance line are formed between the same layers among a plurality of layers sandwiched by a plurality of insulating films, and
between the layers, the signal line is disconnected in a portion in which the signal line and the resistance line cross each other and an interconnection bridge wire for electrically connecting the disconnected portions of the signal line is formed between layers different from the layers.

11. The electro-optical device according to claim 1, wherein a liquid crystal layer is held between the device substrate and a counter substrate which faces the device substrate.

12. The electro-optical device according to claim 1, wherein, in the device substrate, a function layer for an organic electroluminescence element is formed on the pixel electrode.
